(19) United States
(12) Patent Application Publication
(10) Pub. No.: US 2003/0202909 A1
(43) Pub. Date: Oct. 30, 2003

(54) Vacuum manifold and uses thereof

(75) Inventors: George Robert Atkinson, Dorset (GB); Trevor Ruddock, Dorset (GB)

Correspondence Address: FOLEY AND LARDNER, SUITE 500, 3000 K STREET NW, WASHINGTON, DC, 20007, US

(73) Assignee: Genetix Limited

(21) Appl. No.: 10/133,406

(22) Filed: Apr. 29, 2002

(51) Int. Cl. B01L 11/00; B01L 9/00

(52) U.S. Cl. 422/104; 422/101; 422/102; 422/948; 435/288.4; 435/288.5; 436/174; 436/177

(57) ABSTRACT

A dual vacuum chamber manifold for processing well plates. A lower vacuum chamber (35) is formed by arranging a first well plate (25) in the base of the manifold and an upper vacuum chamber (45) is formed above the first well plate by arranging a second well plate on a manifold top plate (34). Pumping on the tipper vacuum chamber via an upper vacuum port (56) generates a vacuum to urge liquid from the upper well plate into the lover well plate. A non-return path between the vacuum chambers ensures that pumping on the upper vacuum port (56) also evacuates the lower vacuum chamber, thereby preventing a pressure differential arising around the lower well plate (25). To process the lower well plate, pumping on a lower vacuum port (58) is performed which closes the non-return path to the second vacuum chamber and thus evacuates the lower vacuum chamber alone. The dual vacuum chamber manifold design reduces well plate handling by allowing vacuum actions to be applied to two well plates in series for only one loading of the manifold. It thereby speeds up processing and reduces contamination risk.

### BACKGROUND OF THE INVENTION

The invention relates to a vacuum manifold for use with filter plates and other kinds of well plates, e.g. pierced or perforated, as used to perform biochemical processes. The invention also relates to uses of a vacuum manifold to carry out such processes, for example in an automated well plate and liquid handling apparatus.

Vacuum manifolds are widely used in conjunction with filter plates and other kinds of well plates to perform biochemical processes, such as purification and assaying of proteins and purifying DNA fragments from polymerase chain reaction (PCR) processes, plasmid DNA preparations or DNA sequencing reactions.

FIG. 1 of the accompanying drawings is an exploded perspective view of a known vacuum manifold. The vacuum manifold comprises a base unit 10 having a vacuum port 12 on one side. A-spacer 14 is arranged on the base unit, with a vacuum seal being formed by a base gasket 16 arranged between the base unit 10 and spacer 14. The manifold is shown in conjunction with a collection plate 18 and a filter plate 20. The collection plate 18 is arranged in the base unit with the filter plate 20 suspended above it supported by the spacer 14. The filter plate 20 seats onto the spacer 14 via a lid gasket 22 in order to form a vacuum seal between the filter plate 20 and spacer 14. Pumping on the vacuum port 12 with a pump (not shown) creates a vacuum in the vacuum chamber formed by the interior of the vacuum manifold and serves to apply downward pressure on the wells of the filter plate, urging their liquid contents into the aligned wells of the collection plate. Vacuum settings in the range 5-25 inches of mercury (0.17-0.85 bar) can be used.

One known application for vacuum manifolds is to purify plasmid DNA using a 96-well format, which is now described by way of example. A filter plate is loaded with lysates from a well culture block. A further filter plate is arranged in the base of a vacuum manifold with the lysate containing plate above it Vacuum is applied in the base of the vacuum manifold to move the lysates from the upper filter plate into the lower filter plate. The upper plate is then removed and discarded. The lower plate is taken out of the vacuum manifold and then rearranged in the vacuum manifold in the upper position. Referring to the manifold of FIG. 1, this step would amount to discarding the well plate 20 and moving well plate 18 into the position shown in FIG. 1 as occupied by well plate 20. Vacuum is then applied to the base of the vacuum manifold to concentrate the samples in the plate. Plasmid DNA is retained on the membrane surface (due to the molecular weight cut off imposed by the membrane pore size) while contaminants are filtered to waste. The process is then completed by washing and resuspension. The DNA solution is then recovered by pipetting from the well plate. A variation on this method uses a filter plate with a DNA binding membrane in place of the molecular weight cut-off membrane. During the transfer of lysate to the DNA binding plate and the subsequent washing steps the composition of the liquid used is such that DNA is bound to the membrane of the DNA binding plate and contaminants are not. In the final recovery step a liquid, e.g. pure water or TE buffer, is added to the DNA binding plate. Under these conditions DNA is released from the membrane and, using vacuum, is pulled through the DNA binding plate into a collection plate beneath.

The above-described process is typical in that it involves a number of plate loading and unloading steps from the manifold. The plate loading and unloading steps are defined by the biochemical processes being carried out and, more specifically, by the need to apply a vacuum underneath specific well plates at certain points in the process.

Processes of this kind are often automated by a robot, which uses a head with a plate manipulation function to load and unload the plates as desired. The robot includes a control system that ensures vacuum is applied at the desired stages.

The loading and unloading of well plates takes up significant amounts of time. In some instances, the time taken up by plate loading and unloading can become the rate-limiting factor for the whole process. Moreover, each well plate manipulation carries a contamination risk.

It would therefore be desirable to reduce the well plate handling in order to speed up the process and reduce contamination risk.

### SUMMARY OF THE INVENTION

According to a first aspect of the invention there is provided a vacuum manifold for processing well plates comprising: a lower well plate retainer for sealingly receiving a it well plate to form a first vacuum chamber below the first well plate; and an upper well plate retainer for sealingly receiving a second well plate to form a second vacuum chamber below the upper well plate and above the lower well plate.

With upper and lower well plates in place, pumping on the second vacuum chamber generates a vacuum therein to urge liquid in the wells of the upper well plate into the aligned wells of the lower well plate. Subsequent processing of the lower well plate can be performed without having to handle the lower well plate again by pumping on the lower vacuum chamber. It is noted that processing of the lower well plate will typically take place after removal of the upper well plate and after further processing of the lower well plate, for example pipetting of additional liquid into the wells of the lower well plate.

The dual vacuum chamber manifold design therefore reduces well plate handling by allowing vacuum actions to be applied to two well plates in series for only one loading of the manifold. It thereby speeds up processing and reduces contamination risk.

The first vacuum chamber may be connected to the second vacuum chamber by a non-ret path, so that pumping on the second vacuum chamber evacuates both the first and second vacuum chambers jointly, whereas pumping on the first vacuum chamber evacuates the first vacuum chamber alone. This ensures that while the upper well plate is being processed, there is no pressure differential surrounding the lower well plate, because the non-return path is open. Subsequent processing of the lower well plate is performed by pumping on the first vacuum chamber which has no pumping effect on the second vacuum chamber because the non-return path is closed.

Pressure equalization between the first and second vacuum chambers can be achieved in a variety of ways. Pressure equalization could be achieved by a non-return path external to the vacuum manifold. Another option would be to provide one or more pressure release valves between the vacuum chambers and an exterior chamber or atmosphere. A further option would be to use a feedback control system with pressure sensors in the vacuum chambers to provide feedback, with separate pumping of the first and second vacuum chambers. This would however be more expensive to implement and add unnecessary complexity to the system.

In an embodiment of the invention, the non-return path incorporates a non-return valve to effect a particularly simple solution. The non-return path is advantageously integrated into the vacuum manifold by an internal conduit therein.

The vacuum manifold may Her comprise a removable spacer sealingly arranged between the lower well plate retainer and the lower well plate, to accommodate a lower well plate of reduced thickness when fitted. The spacer can be removed to allow insertion of thick well plates into the lower well plate retainer.

The vacuum manifold is particularly well suited to automated operations using a suitable robotic apparatus. Automation can be assisted by providing the vacuum manifold with a jacking mechanism for raising a well plate from the lower well plate retainer to offer it up for removal. This allows for easier removal by a standard head of a well plate handling robot, and also for easier hand removal.

The principles of the invention can be extended to beyond a dual vacuum system to provide a vacuum manifold with, in principle, any number of vacuum chambers. Moreover, the use of non-return paths between vertically adjacent vacuum chambers is cascadable, so can also applied in a vacuum manifold with three, four or more vacuum chambers. For example, with a three level system interconnected by non-return paths, pumping on the middle chamber will also pump out the lower chamber, but not have an effect on the upper chamber, since the non-return path from the middle chamber to the upper chamber will be sealed.

If a three chamber manifold is provided, in some applications it may be advantageous to provide a waste chute or gutter to allow wash or waste liquid from the middle well plate to be removed from the manifold without impinging on the lower well plate. Any such chute or gutter is preferably moveable so that it can be moved to allow Free access to the lower well plate after processing the riddle well plate. For example, access may be desired by a liquid handling head of a robot. Movement of the chute or gutter may be manual or automated.

The vacuum manifold may thus include a further (third) well plate retainer arranged below the lower well plate retainer for sealingly receiving a further well plate to form a further vacuum chamber below the lower well plate. Moreover, the farther vacuum chamber can be connected to the first vacuum chamber by a non-return path, so that pumping on the second vacuum chamber evacuates the first, second and further vacuum chambers, pumping on the first vacuum chamber evacuates the fixer and first vacuum chambers alone, and pumping on the further vacuum chamber evacuates the fixer vacuum chamber alone. Furthermore, the vacuum manifold may include a waste chute or gutter arrangeable between the first vacuum chamber and the further vacuum chamber.

According to a second aspect of the invention there is thus provided a well plate handling apparatus comprising a movable head with well plate manipulation capability and a vacuum manifold according to the first aspect of the invention.

A variety of biological and/or chemical processes can be carried out using the vacuum manifold, either by hand, fitly automated or partially automated.

According to a third aspect of the invention there is thus provided a method for carrying out biological and/or chemical processes using well plates, comprising: (a) arranging a first well plate in a vacuum manifold to form a first vacuum chamber below the first well plate; (b) arranging a second well plate in the vacuum manifold above the first well plate so that a second vacuum chamber is formed between the first and second well plates; (c) processing the second well plate by generating equal vacuums in the fist and second vacuum chambers; and (d) processing the first well plate by generating a vacuum in the first vacuum chamber.

The method may further include, between steps (b) and (c), the steps of: removing the second well plate from the vacuum manifold; and performing a handling action on wells of the first well plate.

The handling action may be addition of liquid into wells of the first well plate, for example by pipetting. Other handling actions, such as shaking or stirring may also be performed.

According to a fourth aspect of the invention there is provided use of a well plate handling apparatus comprising a movable head with well plate manipulation capability to perform the method of the third aspect of the invention.

### BRIEF DESCRIPTION OF THE DRAWINGS

For a better understanding of the invention and to show how the same may be carried into effect reference is now made by way of example to the accompanying drawings in which:

FIG. 1 is an exploded view of a prior art vacuum manifold also slowing a lower well plate for liquid collection from an upper well plate;

FIG. 2 is a perspective view of a vacuum manifold according to an embodiment of the invention;

FIG. 3A is an end view of the vacuum manifold of FIG. 2;

FIG. 3B is a lengthwise section of the vacuum manifold of FIG. 2 through the section B of FIG. 3A;

FIG. 3C is a side view of the vacuum manifold of FIG. 2;

FIG. 3D is a crossways section of the vacuum manifold of FIG. 2 through the section A of FIG. 3C;

FIG. 3E is a schematic version of FIG. 3D showing upper and lower well plates positioned in the manifold;

FIGS. 4A to 4H show in schematic section steps of a biochemical process carried out in two well plates using the vacuum manifold of FIG. 2; and

FIG. 5 shows a well plate handling robot using two of the vacuum manifolds of FIG. 2.

### DETAILED DESCRIPTION

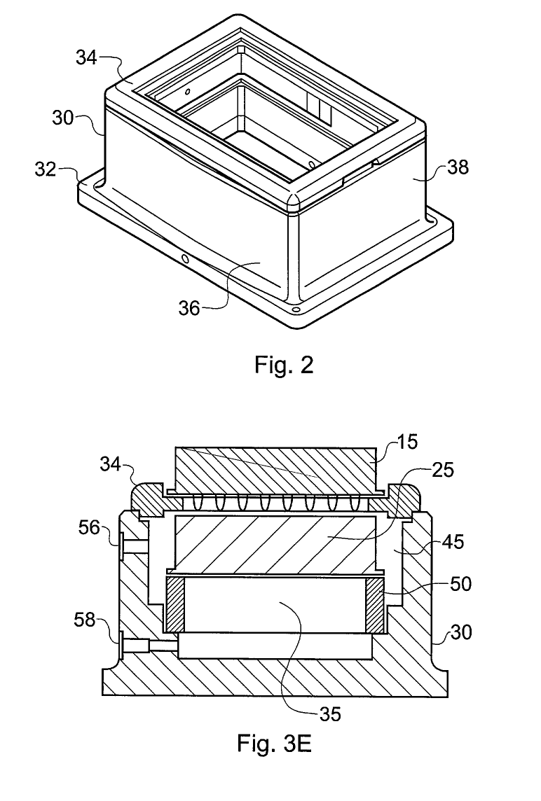

FIG. 2 is a perspective view of a vacuum manifold according to an embodiment of the invention. The manifold has a base unit 30 with a generally rectangular footprint which provides a skirt or flange 32 on its lower face for convenient mounting on the bed of an automated liquid handling robot. The base unit 30 has upstanding side walls 36 and end walls 38. Arranged on top of the walls 36 and 38 of the base unit 30 is a top plate 34. Inside the base unit further structure of the manifold is evident and is now described with reference to the following figures.

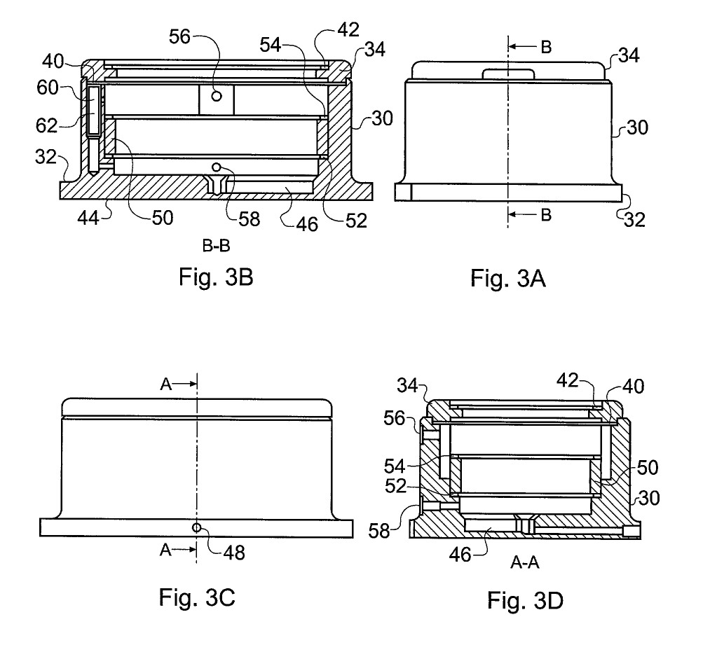

FIG. 3A is an end view of the vacuum manifold with the base unit 30, its skirt 32 and the top plate 34 evident

FIG. 3B is a lengthwise section of the vacuum manifold through the section B of FIG. 3A revealing important parts of the manifold's internal structure.

FIG. 3C is a side view of the vacuum manifold.

FIG. 3D is a crossways section of the vacuum manifold through the section A of FIG. 3C.

FIG. 3E is a schematic version of FIG. 3D showing upper and lower well plates positioned in the manifold.

Referring to FIG. 3B, the top plate 34 is arranged on the upper faces of the walls 36 and 38 through the intermediary of a gasket 40. On the upper side of the top plate 34 a further gasket 42 is arranged, which serves to form a vacuum tight contact with the lower face of a well plate 15 arranged on the top plate 34 to form an upper vacuum chamber 45, as can be seen in FIG. 3E. The base unit 30 has a bottom plate 44 the outer parts of which form the flange 32. The upper interior face of the bottom plate has formed therein drainage channels 46 which lead to an exterior drain port 48 in a the flange 32 (drain port 48 is shown in FIGS. 3C and 3D). In the interior of the base unit 30 there is arranged a spacer 50. The spacer 50 rests on a lip surface formed on the inside of the walls 36 and 38 through the intermediary of a gasket 52. A further gasket 54 is arranged on top of the spacer. The gasket 54 serves to form a vacuum tight contact with the lower face of a well plate 25 arranged on the spacer 50 so that a lower vacuum chamber 35 is formed, as can be seen in FIG. 3E.

The purpose of the spacer 50 can now be appreciated. Namely, it is provided to allow use of both thin and thick well plates in the base unit 30. With the spacer 50 fitted, a thin well plate can be used, as illustrated. With the spacer 50 removed, a tick well plate can be accommodated.

As evident in FIG. 3B, midway along the side wall 36 there is an upper vacuum port 56 and a lower vacuum port 58 which allow pumping on the upper and lower vacuum chambers formed by the well plates in the manner described above. The vacuum ports 56 and 58 take the form of through holes extending through one of the side walls 36, as can b seen in FIG. 3D. The vacuum ports 56 and 58 are connected to eternal vacuum lines (not shown) leading to a pump (not shown).

To the left of FIG. 3B a channel 60 interconnecting the upper and lower vacuum chambers can be seen. The channel 60 is formed of a vertical bore the upper part of which is a greater diameter than the lower part and upper and lower short horizontal bores joining the vertical bore to the interior of the manifold in the upper and lower vacuum chambers 45 and 35 respectively. A non-return valve 62 of cylindrical outer dimension (not shown) is sleeved from above into the upper larger-diameter section of the vertical bore to form a one-way, non-return path. The non-return valve is of the ball-and-cup type such that when pumped from below, a ball forms a seal in a cup and prevents air flow (or other gas flow) in the downwards direction through the channel 60. On the other hand, when pumped from above, the ball is raised away from the cup and held so as to allow air flow in the upwards direction through the channel 60.

The base unit 30 and top plate 34 are made of aluminum. Other metals, for example stainless steel, or non-metal materials, for example plastics or PTFE could also be used. The vacuum levels are very low so that a wide variety of normal materials could be used. The gaskets can be made of synthetic rubber or any other conventional vacuum gasket material.

With reference to FIG. 3E, the operational principles of the vacuum manifold are now summarized. With upper and lower well plates in place, pumping on the upper vacuum port 56 generates a vacuum in the upper vacuum chamber 45 urging liquid in the wells of the upper well plate 15 into the aligned wells of the lower well plate 25. While this is taking place, there is no pressure differential surrounding the lower well plate 25 because the non-return path 60 (FIG. 3B) is open which results in the pumping action on the upper vacuum port evacuating the upper and lower vacuum chambers 45 and 35 in equal measure. As a consequence, there is no pressure driving liquid trough the lower well plate 25 while the upper well plate 15 is being processed. Subsequent processing of the lower well plate 25 is performed by pumping on the lower vacuum port 58 which evacuates the lower vacuum chamber 35, but has no pumping effect on the upper vacuum chamber 45 because the non-return path 60 (FIG. 3B) is closed. It is noted that processing of the lower well plate 25 will typically take place after removal of the upper well plate 15 and after farther processing of the lower well plate 25, for example pipetting of additional liquid into the wells of the lower well plate 25.

It will thus be appreciated that the dual vacuum nature of the manifold allows two handling steps of the prior art to be combined into one, thereby reducing well plate manipulation.

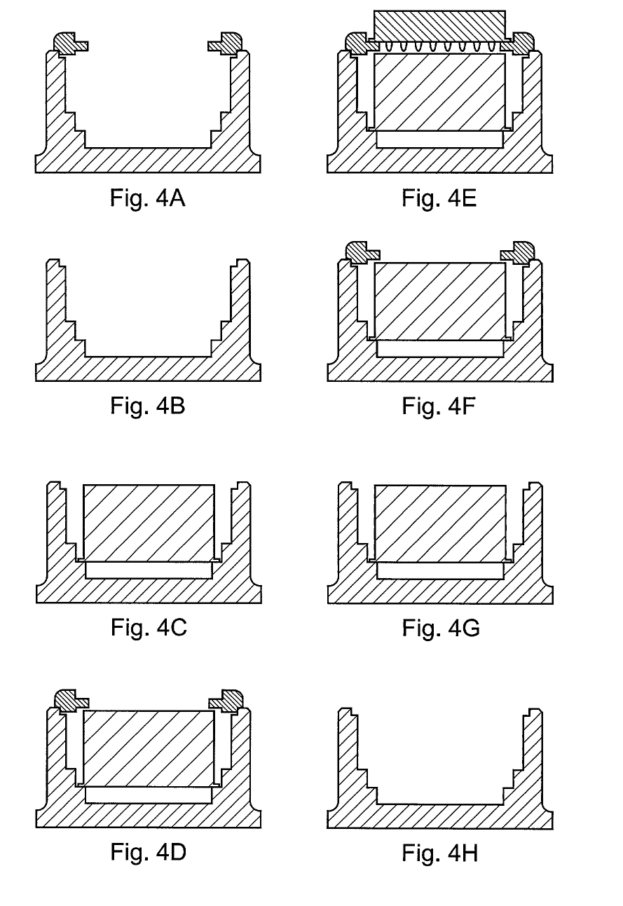

FIGS. 4A to 4H show in schematic section the manifold at different points in an example biochemical process that can be performed on two well plates using the vacuum manifold.

1. A manifold is provided for c g out the process FIG. 4A).

2. The top plate is removed (FIG. 4P).

3. A thick well plate is arranged in the base unit (FIG. 4C).

4. The top plate is replaced (FIG. 4D).

5. A thin filter well plate is arranged on the top plate (FIG. 4E).

6. Vacuum is applied to the upper vacuum port to process the upper, filter well plate.

7. The upper well plate is removed (FIG. 4F).

8. Vacuum is applied to the lower vacuum port to process the lower, thick well plate.

9. The top plate is removed (FIG. 4G). (It is noted that this step could take place prior to the previous step of applying vacuum to the lower vacuum port.)

10. The thick well plate is removed FIG. 4H).

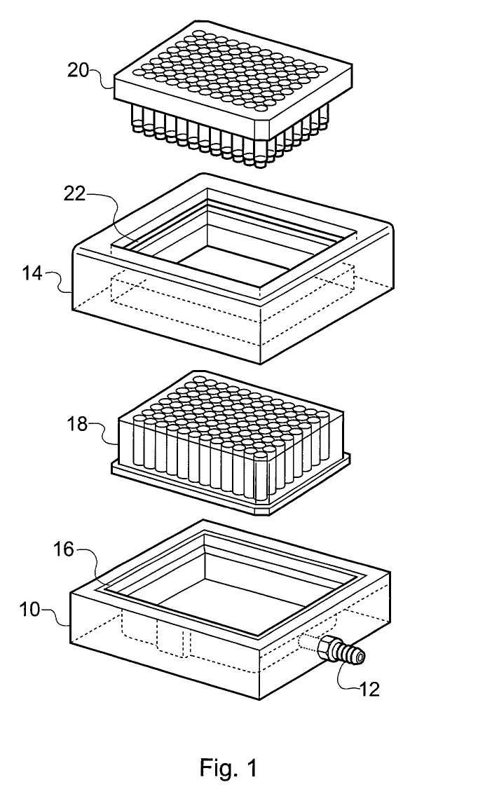

These example steps contrast with those needed to carry out the same biochemical process in a conventional vacuum manifold such as that shown in FIG. 1. With a conventional manifold, the collection well plate (the lower thick well plate in the example) would need to be removed from the bottom of the vacuum manifold and then arranged in the upper position before vacuum could be applied to it, thus increasing the number of handling steps hat need to be carried out either by hand, or by the well plate manipulation head of a robot.

The lower well plate removal process can be assisted by inclusion of a jacking mechanism for raising the lower well plate to offer it up for a well plate handling head of a well plate handling robot. For example, a hydraulically actuated piston assembly can be used with a piston that can be moved between a retracted position and an extended position, the piston extending through the base of the vacuum manifold through a vacuum tight seal, such as an O-ring seal. The piston end can be fitted with a plate which can lift the lower well plate from below. Alternatively, the piston end can act on a plate with three or four upstanding rods, each of which extends through the base of the manifold through vacuum tight seals. Other jacking mechanisms could also be envisaged.

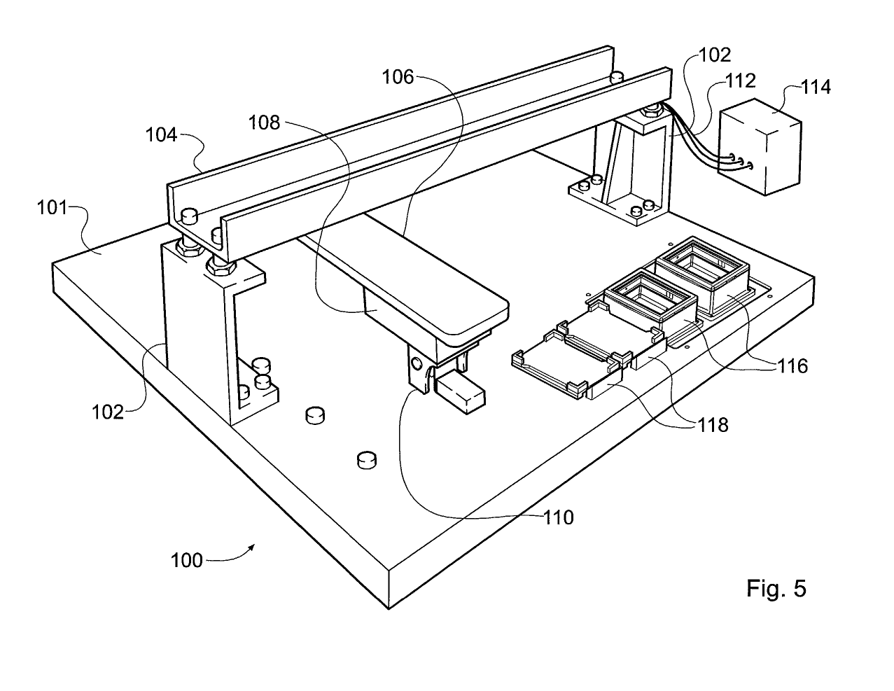

FIG. 5 shows a robotic well plate handling apparatus 100 using the vacuum manifolds described above. The apparatus 100 comprises a main bed 101. An xyz-positioning system is formed by a cross-bar carried by a pair of supports 102 upstanding from the bed 101, the cross-bar carrying an x-positioner 104. The x-positioner 104 carries a y-positioner 106 arranged orthogonal thereto, which in turn caries a z-positioner 108 arranged orthogonal to the x- and y-positioners 104 and 106. The z-positioner 108 carries a liquid handling head 110 with well plate manipulation capability. The system is under control of a control system connected to the apparatus through a control unit 114 via electrical connections 112. Arranged on the bed 101 in a row are two vacuum manifolds 116 embodying the invention and two well plate shakers 118. Vacuum feed lines are not shown for the sake of simplicity, but may conveniently be routed through the bed 101 leading to a pump (not shown) arranged below the apparatus bed 101. The control system coordinates the positioning of the head 110 with the pumping on the vacuum manifolds as desired.

What is claimed is:

1. A vacuum manifold for processing well plates comprising:
a lower well plate retainer for sealingly receiving a first well plate to form a first vacuum chamber below the first well plate; and
an upper well plate retainer for sealingly receiving a second well plate to form a second vacuum chamber below the upper well plate and above the lower well plate.

2. The vacuum manifold of claim 1, wherein the first vacuum chamber is connected to the second vacuum chamber by a non-return path, so that pumping on the second vacuum chamber evacuates bot the first and second vacuum chambers jointly, whereas pumping on the first vacuum chamber evacuates the first vacuum chamber alone.

3. The vacuum manifold of claim 2, wherein the non-return path incorporates a non-return valve.

4. The vacuum manifold of claim 1, fierier comprising a removable spacer sealingly arranged between the lower well plate retainer and the lower well plate, to accommodate a lower well plate of reduced thickness.

5. The vacuum manifold of claim 1, further comprising a jacking mechanism for raising a well plate from the lower well plate retainer to offer it up for removal.

6. The vacuum manifold of claim 1, including a further well plate retainer arranged below the lower well plate retainer for sealingly receiving a Per well plate to form a further vacuum chamber below the lower well plate.

7. The vacuum manifold of claim 6, wherein the further vacuum chamber is connected to the second vacuum chamber by a non-return path, so that pumping on the second vacuum chamber evacuates the first, second and further vacuum chambers, pumping on the first vacuum chamber evacuates the further and first vacuum chambers alone, and pumping on the further vacuum chamber evacuates the further vacuum chamber alone.

8. A well plate handling apparatus comprising a movable head with well plate manipulation capability and a vacuum manifold according to claim 1.

9. A method for carrying out biological and/or chemical processes using well plates, comprising:
(a) arranging a first well plate in a vacuum manifold to form a first vacuum chamber below the first well plate;
(b) arranging a second well plate in the vacuum manifold above the first well plate so that a second vacuum chamber is formed between the first and second well plates;
(c) processing the second well plate by generating equal vacuums in the first and second vacuum chambers; and
(d) processing the first well plate by generating a vacuum in the first vacuum chamber.

10. The method of claim 9, further including, between steps (b) and (c), the steps of:
removing the second well plate from the vacuum manifold; and
performing a handling action on wells of the first well plate.

11. The method of claim 10, wherein the handling action is addition of liquid into wells of the first well plate.

12. Use of a well plate handling apparatus comprising a movable head with well plate manipulation capability to perform the method of claim 9.
